(19) United States
(12) Patent Application Publication
(10) Pub. No.: US 2008/0133256 A1
(43) Pub. Date: Jun. 5, 2008

(54) My pet ID collar

(76) Inventors: Lisa Anne Speroni, Greenbrier, TN (US); Robert Drew Kaufman, Greenbier, TN (US)

Correspondence Address: Lisa Speroni, 1868 Lake Road, Greenbrier, TN, 37073, US

(21) Appl. No.: 11/607,421

(22) Filed: Dec. 1, 2006

(51) Int. Cl. A01K 27/00; G06Q 99/00

(52) U.S. Cl. 705/1

(57) ABSTRACT

The invention sole purpose is to act first as a method of identification and recovery system and as a collar second. There is a unique 12-digit sequence ID number, along with a 24 hours a day 365 day toll-free number which accesses live operators to assist in the recovery effort. Pet owners may register their pets be it, online international website, email, or by traditional mean of the U.S. Postal Service via. mail. The finders of lost pets may search the main website computer system in an attempt to match the ID collars number, and locate the owners of lost pets. One size fits all with a greater variety of holes for the adjustment of the length of the collar, wherein a strap has a buckle at one end and the connecting holes at the other end, which is then cut to size and fasten with two additional rubber fitted brace bands. The collar also has a glow-in-the-dark feature.

### CROSS REFERENCE TO RELATED APPLICATIONS

Not Applicable

### FEDERALLY SPONSORED RESEARCH

Not Applicable

### DESCRIPTION OF ATTACHED APPENDIX

Not Applicable

### FIELD OF THE INVENTION

This invention encompasses a multiplicity of methods for locating and returning lost animals/pets with their owners.

A unique 12-digit sequence ID number appears on every (ID collar)—My Pet ID Collar. That unique number identifies only that pet with that number, there are no duplicate numbers issued in the 12-digit sequence. There are four ways the unique ID is enter into the international database:

1, The registration form located inside the product packaging is mailed in along with a photo of the pet, and a customer service person manually scans and uploads the pets photo then enters in the persons and their pets information in the international web database.
2, The registration form located inside the product packaging is faxed in along with a photo of the pet, and a customer service person manually scans and uploads the pets photo then enters in the persons and their pets information in the international web database. If the pet owners move and/or change phone numbers, they may contact call center or make changes themselves in/on the computer at any time and update their contact information.
3, The pet owner calls our toll-free number and one of our customer service operators walks the pet owner through the registration steps and they upload of the pets photo. Or, our customer service person takes the information orally then manually enters it into our in the international web database without a photo of the pet.

### 4, The pet owner goes directly to our website and manually scans and uploads their pets photo then enters in information in the international web database.

Once that number is register in our international database along with contact data about the owners and pet's information, the lost/missing pet can be located anywhere in the world.

### 5. A lost ID Pet Alert notification scrolls across the front-page of the computer screen for creation of individualized notifications of lost pets to be transferred via the global computer network.

Other methods for locating lost pets include implanting identifying microchips in the pets or tattooing the pets. Both of these methods are expensive and painful for the pets and do not permit a finder of a pet to search for and contact the pet's owner at any time of day. Moreover, with the microchip methods the finder of the pet must know that the pet has an implanted microchip in them, and then locate a veterinarian or other animal facility that has an up-to-date microchip scanner that can read the implanted microchip. Since with the new technologically has created the microchips with more meg-hertz and cannot be read by most scanners at veterinarians, or shelters. Several Internet web sites exist that assist in locating lost pets. These sites use a variety of methods such as posting pictures and descriptions of lost pets and information regarding where pets that were lost. Unfortunately, the descriptions and information posted on these sites is often too limited and subjective to permit an exact match between a lost pet and its owner. Moreover, pet owners who lose their pets often do not add descriptions of their lost pets to these sites until days after their pets have been lost. By then If a person finds a pet and accesses one of the sites before the pet owner adds a description of the lost pet to the site, the finder will be unable to locate the pet owner.

### BACKGROUND OF THE INVENTION

There has been an urgent need for an identification system that works on a national and international database for locating lost pets, especially in the after math of the 2005 hurricane season where over 600,000 pets were displaced, injured or died being out of site of their owners. Last year over 12 million pets, both dogs and cats alike, went missing from their homes. Many were found in animal shelters, others weren't so lucky. These stray cats and dogs end up picked up by animal control around the country and taken to shelters and if they are not claimed with, 72 hours they are euthanized simply because there was no way of identifying them while others have even been given new homes leaving their original owners behind. Only 16% of lost dogs and 2% of lost cats ever return to their owners!

A “D” ring is currently used on all collars allowing for an ID tag to hang from a collar for identification proposes this can be made of plastic or some kind of metal alloyed is engraved or even hand written contact information on the collar. However, they these ID tags often fall off, or either by normal wear and tear, scratches, dents, become illegible.

Other collars offer an area on the collar for an owner hand write the contact information on but often it is not sufficient amount of a space for and or the information does not get changed when an owner relocates to another house or state. In today's environment most pet owners are hesitate to release their private information for anyone to see and the owner becomes vulnerable to would be burglars or worse.

The present invention relates to a collar used as an Identification system, with the added protection of illumination—the composition elements make it possible for the collar to glow-in-the-dark. The when a pet is either on a leash or is walking off of one the animal is still visible to the driver in automobile which is dangerous or sometimes even deadly to an animal without some kind of illumination.

### SUMMARY OF THE INVENTION

It is consequently an object of this invention to provide a system for identifying lost domestic pets by locating the owner and pet through one unique ID number stored in our international registry. Finally, the collar provides the finder of the lost pet the ability obtain immediate information about the pet and the pet owner, which the pet owner indicated when registering the collar ID number. Reuniting the pet with the owner via: Internet, toll-free telephone number, or through one of the registries trained operators at our call center. Preferred data of the pet includes name, telephone number, email, all other reach numbers, and address.

Trained operators are located at central data information terminal center which are live 24 hours a day 365 days a year to response to any incoming lost or found pet and to able to the contact pet owner if the contact information was to remain private on their account. The data terminal handled via live operators has the ability to correlate the ID number found on the collar and that information put in by the pet owner allowing the identification system to reunite the pet and the owner.

The present inventor has developed a system, which utilizes the technological power provided by the global computer network (“Internet”) to provide an intelligent and powerful pet notification system in a matter of seconds. The notification system has the capability of retaining information about pets and their owners, including photographs.

There by the present invention solves the above-described problems and provides a distinct advance in the art of lost pet location methods and systems. More particularly, the present invention provides a nationwide and international, web-based pet registration, search, and retrieval system that is highly effective, inexpensive, and easy to use.

### DETAIL OF DESCRIPTION

The My Pet ID Collar is a nationwide and international pet registration, search, and retrieval system. The system which is implemented using a toll-free number and our web-based integrated database system, operates 24 hours a day 365 days a year with live operators to assist in the recovery effort, and is available to a wider array of pet. The pet owner decides how much, if any, of contact data they want potential finders of their lost pet to see. They may display their name; address; all types of telephone numbers, including home, office, cell, voice mail, and pager; and even your e-mail address. The more information they choose to display, the more avenues people have to reach the pet owner immediately and directly. Registered accountholders can modify their display options at anytime, as well as instantly update their information in our database. Optionally, the pet owner may elect to display no personal contact information; in which case, potential finders of the lost pet can call My Pet ID Collar's toll-free, 24-hour lost and found hotline. Our trained recovery operators will, then, contact the pet owner with the finder's name and telephone number, and help arrange the quick return of their loved one.

With My Pet ID Collar your pets information is safe and secure in our database, so anyone who finds them just calls the Toll Free number or enters the ID# on the collar on our website with the information you provided, and you and your pet are reunited. Which could mean the difference between life and death for you best friend?

In on embodiment the indicative information is waterproof, scratch proof, and glows-in-the-dark applied by hand in the technical process of thermal heated silk-screened into and onto the collar.

### BRIEF DESCRIPTION OF THE DRAWINGS

FIG. 1 shows one of any domestic animal/house hold pet wearing the collar.

FIG. 2 illustrates the frontal components of the preferred embodiment of the invention.

FIG. 3 illustrates the back components of the preferred embodiment of the invention.

### BRIEF DESCRIPTION OF THE PREFERRED DRAWINGS

A preferred embodiment of the present invention is described in detail below with reference to the attached in detailed drawing of figures, wherein:

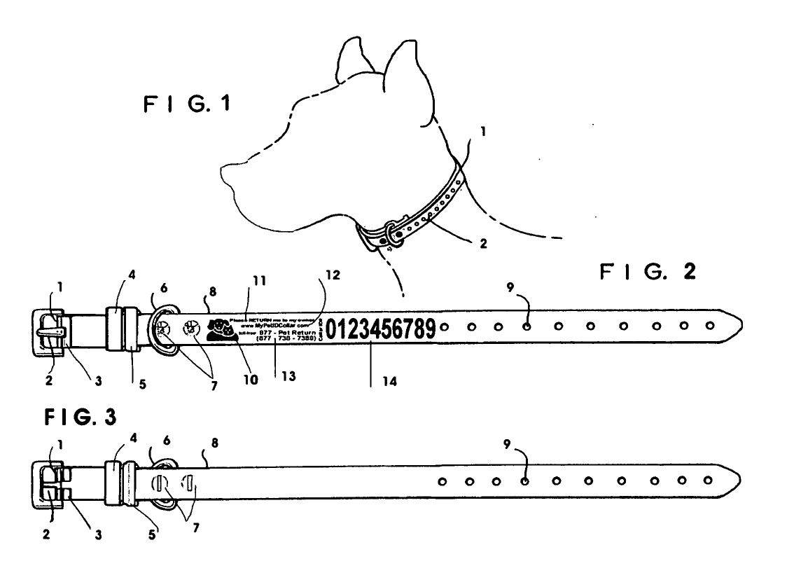

Referring now to FIG. 1, show a domestic animal be it cat, dog, pig, lizard, ferrite, etc. wearing the ID collar. Closing is illustrated with the buckle with the pin that pivots along the axis. 1. of FIG. 1, also indicates

The collar illumination, glow-in-the-dark abilities. 2 of FIG. 1, indicates the adjustable holes to allow one size fits all. FIG. 2, shows the collar fully stretch out with indication of all embodied elements of the frontal view of FIG. 2, points to the rotating axis of the buckle, 2. of FIG. 2, indicates the pin that pivots through the holes of the collar, 3. of FIG. 2, shows the metal brace which secures the collar strap with the Buckle attach by the under lapping end, 4. of FIG. 2, shows one of two rubber silicone bands which secures the overlap of the collar after adjustment in place, 5. of FIG. 2, is the second of the silicone bands with an added lip—indicating a higher surface for a tighter placement to secure collar from coming loose or unfastened. 6. of FIG. 2, this is the “D” link used for a variety of reason/purposes—for a leash to be attach for walking the pet, a tag of some kind to be attached, etc. the “D” link is set in place by the under lapping of the collar with two of the stainless steel front of metal screws indicated in FIG. 7. of FIG. 2; 8, of FIG. 2, represents the ID Collar it self as the full embodiment of the invention. 9. of FIG. 2, is one of 50 plus holes in the collar for breath-ability and size adjustment. 10. of FIG. 2, shows the collar logo, 11. of FIG. 2, gives instructions to the finder of the lost pet what to do: “Please Return Me To My Owner”, 12. of FIG. 2, give the international website address, 13. of FIG. 2, shows to formats of the toll-free telephone number in which the finder of the lost pet can call and locate a pet owner, 14. of FIG. 2, is the 12-digit unique sequence ID number appears on every (ID collar), which is the embodiment of the collar it self identifying both the owner and the pets vital information that will be the key in re-uniting the two. FIG. 3, 1, shows the collar fully stretch out with indication of all embodied elements of the back view; 1. of FIG. 3, points to the backside of the rotating axis of the buckle, 2. of FIG. 3, indicates the pin that pivots through the holes of the collar, 3. of FIG. 3, shows the back of the metal brace which secures the collar strap with the buckle attach by the under lapping end and how it clips to the collar, 4. of FIG. 3, shows one of two rubber silicone bands which secures the overlap of the collar after adjustment in place, 5. of FIG. 3, is the second of the silicone bands with an added lip—indicating a higher surface for a tighter placement to secure collar from coming loose or unfastened. 6. of FIG. 3, this is the “D” link used for a variety of reason/purposes—for a leash to be attach for walking the pet, a tag of some kind to be attached, etc. the “D” link is set in place by the under lapping of the collar with two of the stainless steel backside of metal screws indicated the indention for adjustment; 7, 7. of FIG. 3, are the backside of stainless steel metal screws represents the ID Collar it self as the full embodiment of the invention. 8. of FIG. 3, 9. of FIG. 2, is one of 50 plus holes in the collar for breath-ability and size adjustment.

Preferably, the number is easily identifiable with the company's recognizable logo connected with the information about pets and their owners can be entered into and retrieved from a central database.

The information about the pets and their owners is stored according to a code number permanently imbedded in to the pet collar. show in detail the design and use of the preferred pet collar. The collar is able to withstand weather conditions, scratching by the pet, and so forth. The collar it self is made of silicone known construction material, and can be varied to suit the tastes of individual pet owners and also the type of pet. It is contemplated that the primary use for the collars will be for dogs and cats, but the collars could be adapted for use on any other pet capable of wearing a collar and of getting lost.

Permanently attached to or imprinted on the collar is a code/ID number (XXX000XXX000) which is unique to that collar. The code/ID number imprinted by, for example, embossing it directly onto the collar, or permanently imbedded into the collar. The code/ID number may be imprinted on the collar by any known method, or engraved if the tag is made of metal or plastic.

Along with the code/ID number, the above-mentioned toll-free telephone number is also imbedded into the collar or imprinted on the collar, as well as instructions relating to its use, such as: “For Information about Please Return Me to My Owner, call toll-free 1-800-XXX-XX

When a pet is wearing the ID collar and is found, the finder is directed to call the toll-free number and an operator will ask for the code/ID number on the collar. Once the code/ID number is obtained by a match from the finder, the information about the pet and its owner retrieved from data base. The finder also has the option to access the international website following the same process the finder enters the code/ID number into/onto the site which then finds a match or does not find a match for the code/ID number enter.

If the finder of the pet is an animal control officer, the pet may be spared the fate which awaits its fellow strays whose owners cannot be located. Essentially, then, the invention includes a method, a system, a id collar which provides both privacy and peace of mind for the pet owner, ensuring that if his or her pet is lost, the finder will be able to quickly identify the pet and return it to its owner. While the invention has been illustrated and described in the foregoing embodiments, it will be recognized that variations and changes may be made therein without departing from the invention claimed.

The preferred embodiment of this invention, and is claimed as new and desired means for pets to be protected by Letters Patent includes the following:

1. A method of locating lost pets comprising of the following steps:
(a) Coordinating a notification procedure for aiding in the locating of a missing pet via the internet a global computer network: providing a means for submission of identification data in the registration of a particular pet:
(b) every collar is issued with a unique alpha-numeric 12-digit ID sequence number that identify that pet with the correct pet owner, additional information displayed on the collar is the company logo, name of the collar “My Pet ID Collar.”, a toll-free phone number to contact our international operation center to assist in reuniting the pet with its owner, the company website address where the 12-digit sequence ID number data that corresponds with the owners information can be obtain by a train operator or the finder themselves, and text reading “Please Return Me To My Owner”.
(c) by submitting/registration the unique 12-digit sequence ID number onto/into the international website database via ID number the information relating to the pet and pet owners contact information is then stored in a main terminal center; said identifying data in a computer, is in a retrievable format accessible via the global internet computer network; with computer-readable memory accessible only by a trained operator at the center using the computer, or the finder by entering the correct 12-digit ID number providing the person whom found the lost pet with the contact information for the owner of the lost pet if a match is found, which would then provide the finder with selected contact information consisting of the owners/veterinarians address and telephone number; providing a means for global retrieving the pets and owners pertinent critical data thereto;
(d) an encrypted code has been developed and installed permitting access only by the person who finds a pet to or an operator with the corresponding collar ID number the ability to access the main database, only if a match is found in the computer system via network: the internet; only then would said data with the contact information for the owner of the lost pet be visible.
(e) The computer program wherein the pet database comprises of information selected from the pet's name, an indication of a pet type for the pet, an indication of a breed of the pet, and a color of the pet, pet owner's name, the pet owner's address, and the pet owner's telephone number; a name for the pet's veterinarian, a phone number for the pet's veterinarian,
(f) providing the person who finds a lost pet to access the main terminal's database via the internet network for information relating to the lost pet; able to compare the ID collar number entered by the person who found the lost pet with the 12 digit number in the database provided by the pet owners in an attempt to find a match: only the would the database provide the person who found the lost pet with the contact information for the owner of the lost pet if a match is found.
